(19) United States
(12) Patent Application Publication
(10) Pub. No.: US 2016/0239886 A1
(43) Pub. Date: Aug. 18, 2016

(54) SYSTEMS AND METHODS FOR FACILITATING USER SELECTION EVENTS OVER A NETWORK

(71) Applicant: PAYPAL, INC., San Jose, CA (US)

(72) Inventors: Karenina Susilo, San Jose, CA (US); Hilary C. Holmquest, Menlo Park, CA (US); Peter E. Liljegren, San Francisco, CA (US); Roel Edward Bebe Ramirez, Hayward, CA (US); Ohad Ravid, London (GB)

(21) Appl. No.: 15/135,474

(22) Filed: Apr. 21, 2016

Related U.S. Application Data
(63) Continuation of application No. 12/413,402, filed on Mar. 27, 2009.

(51) Int. Cl. G06Q 30/06; H04L 29/08

(52) U.S. Cl. CPC G06Q 30/0605; G06Q 30/0617; G06Q 30/0635; G06Q 30/0641; H04L 67/02

(57) ABSTRACT

In accordance with embodiments of the present disclosure, systems and methods for facilitating transactions over a network utilize a first component adapted to communicate with a user via a client device over the network and a merchant via a merchant device over the network and a second component adapted to monitor user navigation events over the network, generate a user selection group based on user selections, track user selections, and display user selections to the user via a selection window provided on the client device.

### CROSS-REFERENCE TO RELATED APPLICATIONS

This application is a continuation of U.S. patent application Ser. No. 12/413,402, filed Mar. 27, 2009, the entirety of which is incorporated herein by reference.

### BACKGROUND

1. Technical Field

The present invention generally relates to network transactions and, more particularly, to facilitating user selection events over a network.

2. Related Art

In electronic commerce, a user typically shops merchant sites, makes purchases, and pays for products through electronic communications with online service providers over communication networks, such as the Internet. During the course of searching and shopping for products, the user typically places selected products in a virtual shopping cart. However, to view the virtual shopping cart, the user is often redirected from a current webpage to another webpage for viewing the contents of the virtual shopping cart. Unfortunately, this is often time-consuming and inconvenient for the user. Accordingly, there exists a need to simplify the process of shopping over a network.

### SUMMARY

In accordance with one or more embodiments of the present disclosure, systems and methods presented herein facilitate network transactions including user selection events over a network. In one embodiment, a system includes a first component adapted to communicate with a user via a client device over the network and a merchant via a merchant device over the network and a second component adapted to monitor user navigation events over the network, generate a user selection group based on user selections, track user selections, and display user selections to the user via a selection window provided on the client device.

In various implementations, the second component of the system may be adapted to receive a user login request from the user over the network via the client device and process the user login request by verifying the identity of the user and locating a user account related to the user. The second component may be adapted to update user selections in the selection window provided on the client device and store user selections in the selection window provided on the client device. The system may comprise a network server having the second component adapted to communicate with the client device and the merchant device over the network, and the merchant device may comprise a network server adapted to communicate with the client device and the second component of the system over the network.

In various implementations, the client device may include a user interface application adapted to allow the user to access the merchant device via the network and search items for purchase consideration. The client device may also include a display component adapted to display user selections to the user via the selection window for purchase consideration.

In various aspects, the user navigation events may include user navigation and/or shopping events related to searching for items to purchase from a website provided by the merchant over the network via the merchant device. The user selection group may include a collection of one or more items moved to the selection window of the client device from the merchant website. The user selections may include one or more items selected for purchase by the user, and the items may include one or more products and services provided by the merchant for purchase over the network via the merchant device.

In one embodiment, a method for facilitating transactions including user selection events over a network may include communicating with a user via a client device over the network and a merchant via a merchant device over the network, monitoring user navigation events over the network, generating a user selection group based on user selections, tracking user selections, and displaying user selections to the user via a selection window provided on the client device. In one implementation, the method may include receiving a login request from the user over the network via the client device and processing the user login request by verifying the identity of the user and locating a user account related to the user. In another implementation, the method may include updating user selections in the selection window provided on the client device and storing user selections in the selection window provided on the client device.

These and other features and advantages of the present disclosure will be more readily apparent from the detailed description of the embodiments set forth below taken in conjunction with the accompanying drawings.

### BRIEF DESCRIPTION OF THE DRAWINGS

FIG. 1 shows a block diagram of a system adapted to facilitate user selection events over a network, in accordance with an embodiment of the present disclosure.

FIG. 2 shows one embodiment of selecting an item icon from a merchant item list and moving the selected item icon to a selection window, in accordance with an embodiment of the present disclosure.

FIG. 3 shows one embodiment of a method for facilitating a client-side selection event over a network, in accordance with an embodiment of the present disclosure.

FIG. 4 shows one embodiment of a method for facilitating server-side processing of a user selection event over a network, in accordance with an embodiment of the present disclosure.

FIG. 5 is a block diagram of a computer system suitable for implementing one or more embodiments of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Embodiments of the present disclosure are directed to systems and methods for facilitating user selection events over a network, such as the Internet. In one aspect, user selection events occur during online navigation and shopping. For example, during online shopping, users access a merchant site, search for desirable items, and monitor merchant items with an intent to purchase the items at another time. Some online service providers offer users a large selection of items for purchase consideration. Embodiments of the present disclosure provide an effective way to quickly set aside items for purchase consideration while continuing online navigation and shopping. Embodiments of the present disclosure provide a readily accessible selection window in a computer desktop environment that allows the user to virtually carry one or more selected items during navigation and shopping. The selection window allows the user to collect, organize, display, and monitor selected items for purchase consideration. These and other aspects are described in greater detail herein.

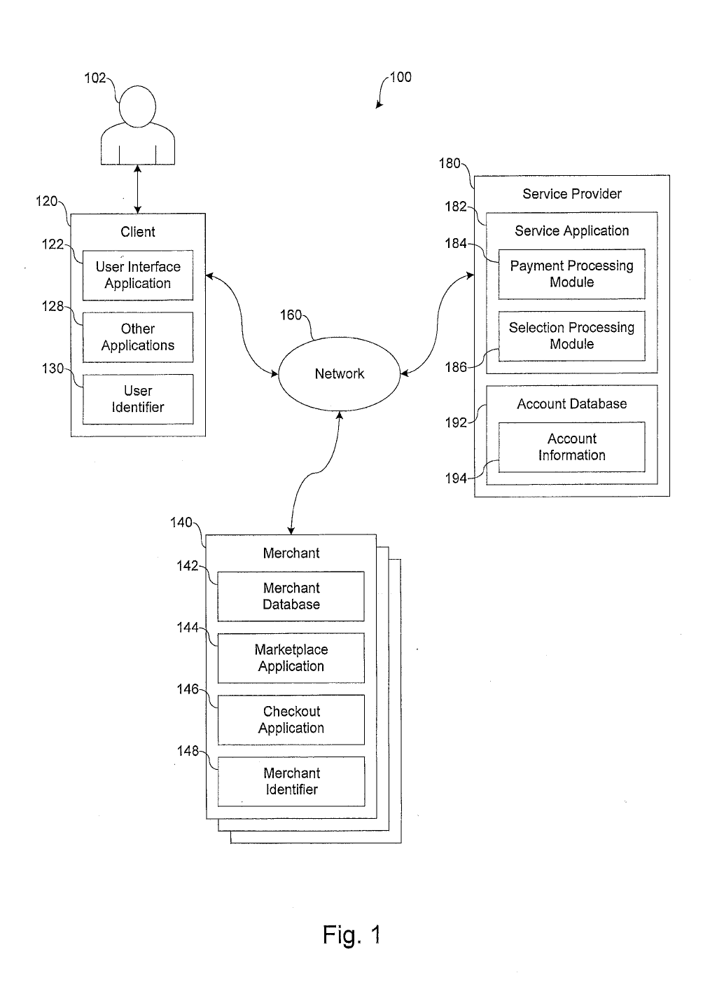

FIG. 1 shows one embodiment of a block diagram of a system 100 adapted to facilitate user selection events over a network 160. As shown in FIG. 1, the system 100 includes at least one client device 120 (e.g., network computing device), one or more merchant devices 140 (e.g., network server devices), and at least one service provider device 180 (e.g., network server device) in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, the client device 120, merchant servers 140, and service provider 180 may be associated with a particular link (e.g., a link, such as a URL (Uniform Resource Locator) to an IP (Internet Protocol) address).

The client device 120, in various embodiments, may be implemented using any appropriate combination of hardware and/or software configured for wired and/or wireless communication over the network 160. In one example, the client device 120 may be implemented as a personal computer (i.e., PC) in communication with the network 160, such as the Internet. In various other examples, the client device 120 may be implemented as a wireless telephone (e.g., cellular phone), a personal digital assistant (PDA), a notebook computer, and/or various other generally known types of wired and/or wireless computing devices. It should be appreciated that the client device 120 may be referred to as a user device or a customer device without departing from the scope of the present disclosure.

The client device 120, in one embodiment, includes a user interface application 122, which may be utilized by the user 102 to conduct financial transactions (e.g., shopping, purchasing, bidding, etc.) with the service provider server 180 over the network 160. For example, the user interface application 122 may be implemented as an item selection application to track, manage, and store information related to the purchase of items, products, and/or services over the network 160. In one aspect, purchase expenses may be directly and/or automatically debited from an account related to the user 102 via the user interface application 122, in a manner as described herein.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160. In another example, the user 102 is able to access merchant websites via the one or more merchant servers 140 to view and select items, products, and/or services for purchase, and the user 102 is able to purchase items, products, and/or services from the one or more merchant servers 140 via the service provider server 180. Accordingly, the user 102 may conduct financial transactions (e.g., purchase and provide payment for items, products, and/or services) from the one or more merchant servers 140 via the service provider server 180.

The client device 120, in various embodiments, may include other applications 128 as may be desired in one or more embodiments of the present disclosure to provide additional features available to the user 102. In one example, such other applications 128 may include security applications for implementing client-side security features, programmatic client applications for interfacing with appropriate application programming interfaces (APIs) over the network 160, and/or various other types of generally known programs and/or software applications. In still other examples, the other applications 128 may interface with the user interface application 122 for improved efficiency and convenience. For example, files, data, and/or information may be imported from various types of accounting software (e.g., a spreadsheet application) directly into the user interface application 122 for improved tracking of purchases and expenses for purchases via the network 160.

The client device 120, in one embodiment, may include at least one user identifier 130, which may be implemented, for example, as operating system registry entries, cookies associated with the user interface application 122, identifiers associated with hardware of the client device 120, or various other appropriate identifiers. The user identifier 130 may include one or more attributes related to the user 102, such as personal information related to the user 102 (e.g., one or more user names, passwords, photograph images, biometric ids, addresses, phone numbers, etc.) and banking information (e.g., one or more banking institutions, credit card issuers, user account numbers, security data and information, etc.). In various implementations, the user identifier 130 may be passed with a user login request to the service provider server 180 via the network 160, and the user identifier 130 may be used by the service provider server 180 to associate the user 102 with a particular user account maintained by the service provider server 180, in a manner as described herein.

The one or more merchant servers 140, in various embodiments, may be maintained by one or more business entities (e.g., merchant sites, resource information sites, utility sites, real estate management sites, social networking sites, etc.) offering various items, products, and/or services for purchase and payment, which may need registration of the user identity information as part of offering the items, products, and/or services to the user 102 over the network 160. As such, each of the one or more merchant servers 140 may include a merchant database 142 for identifying available items, products, and/or services, which may be made available to the client device 120 for viewing and purchase by the user 102.

Each of the merchant servers 140, in one embodiment, may include a marketplace application 144, which may be configured to provide information over the network 160 to the user interface application 122 of the client device 120. For example, the user 102 may interact with the marketplace application 144 through the user interface application 122 over the network 160 to search and view various items, products, and/or services available for purchase in the merchant database 142.

Each of the merchant servers 140, in one embodiment, may include a checkout application 146, which may be configured to facilitate online financial transactions (e.g., purchase transactions) by the user 102 of items, products, and/or services identified by the marketplace application 144. As such, in one aspect, the checkout application 146 may be configured to accept payment information from the user 102 over the network 160.

Each of the merchant servers 140, in one embodiment, may include at least one merchant identifier 148, which may be included as part of the one or more items, products, and/or services made available for purchase so that, e.g., particular items, products, and/or services are associated with particular merchants In one implementation, the merchant identifier 148 may include one or more attributes and/or parameters related to the merchant, such as business and banking information. The merchant identifier 148 may be passed to the service provider server 180 when the user 102 selects an item, product, and/or service for hold, monitor, and/or purchase. The merchant identifier 148 may be used by the service provider server 180 to associate particular items, products, and/or services selected, monitored, and/or purchased with a particular merchant account maintained by the service provider server 180. As described in greater detail herein, the user 102 may conduct financial transactions (e.g., selection, monitoring, purchasing, and/or providing payment for items, products, and/or services) with each merchant server 140 via the service provider server 180 over the network 160.

In various embodiments, each of the one or more business entities having a related merchant server 140 may need to establish at least one merchant account with the service provider server 180. When establishing a merchant account, each of the one or more business entities may need to provide business information, such as owner name, owner address, social security number, date of birth, phone number, email address, etc., and financial information, such as banking information, merchant account information, credit card information, payment processing information, etc.

The service provider server 180, in one embodiment, may be maintained by an online transaction processing entity, which may provide processing for online financial transactions and/or information transactions between the user 102 and one or more of the merchant servers 140. As such, the service provider server 180 includes a service application 182, which may be adapted to interact with each client device 120 and/or each merchant server 140 over the network 160 to facilitate the selection, purchase, and/or payment of items, products, and/or services by the user 102 from one or more of the merchant servers 140. In one example, the service provider server 180 may be provided by PayPal, Inc. and/or eBay of San Jose, Calif., USA.

The service application 182, in one embodiment, utilizes a payment processing module 184 to process purchases and/or payments for financial transactions between the user 102 and each of the merchant servers 140. In one implementation, the payment processing module 184 assists with resolving financial transactions through validation, delivery, and settlement. As such, the service application 182 in conjunction with the payment processing module 184 settles indebtedness between the user 102 and each of the merchants 140, wherein accounts may be directly and/or automatically debited and/or credited of monetary funds in a manner as accepted by the banking industry.

The service application 182, in one embodiment, utilizes a selection processing module 186 to process and monitor user selection events during online shopping by the user 102. In one aspect, the selection processing module 184 allows the service provider 180 to process and monitor user selections during online navigation and shopping events over the network 160. For example, the service provider 180 interfaces with the client device 120 via, e.g., a browser window to monitor the user 102 during navigation and shopping events on various merchant sites. The selection processing module 186 monitors user selection (e.g., drag-and-drop) of merchant icons representing items, products, and/or services to a selection window provided on a display of the client device 120. The selection window may include one or more item selection boxes adapted to receive one or more merchant icons when transferred from the merchant site. Further scope and function related to the selection processing module 186 and the selection window is described in greater detail herein.

In accordance with one or more embodiments of the present disclosure, online and network-based business entities (e.g., merchant sites, resource information sites, utility sites, real estate management sites, social networking sites, etc.) offer selection of items, products, and/or services for users to view, select, monitor, compare, and/or purchase. The selection processing module 186 provides an effective way to set aside selected items, products, and/or services for consideration during an online shopping process. Advantageously, the selection processing module 186 does not redirect the user 102 away from current navigation events and shopping paths to view the selected items, products and/or services on the list. In one implementation, the selection processing module 184 may be uploaded to the user interface application 122 for interfacing with a browser application that may be adapted to follow the user 102 during navigation and shopping events, and allow the user 102 to select and place items, products, and/or services in the selection window for viewing during navigation and shopping events. In another aspect, the user 102 may hold the selected items, products, and/or services in the selection window and decide to compare, monitor, and/or purchase the selected items, products, and/or services in the selection window. In still another aspect, the user 102 may move or transfer the selected items, products, and/or services from the selection window to a watch list for comparing, monitoring, and/or purchasing.

The service provider server 180, in one embodiment, may be configured to maintain one or more user accounts and merchant accounts in an account database 192, each of which may include account information 194 associated with one or more individual users (e.g., user 102) and merchants (e.g., one or more merchants associated with merchant servers 140). For example, account information 194 may include private financial information of each user 102 and each merchant associated with the one or more merchant servers 140, such as one or more account numbers, passwords, credit card information, banking information, or other types of financial information, which may be used to facilitate online financial transactions between the user 102 and the one or more merchants associated with the merchant servers 140. In various aspects, the methods and systems described herein may be modified to accommodate users and/or merchants that may or may not be associated with at least one existing user account and/or merchant account, respectively.

In one implementation, the user 102 may have identity attributes stored with the service provider server 180, and the user 102 may have credentials to authenticate or verify identity with the service provider server 180. User attributes may include personal information and banking information, as previously described. In various aspects, the user attributes may be passed to the service provider server 180 as part of a login, selection, purchase, and/or payment request, and the user attributes may be utilized by the service provider server 180 to associate the user 102 with one or more particular user accounts maintained by the service provider server 180.

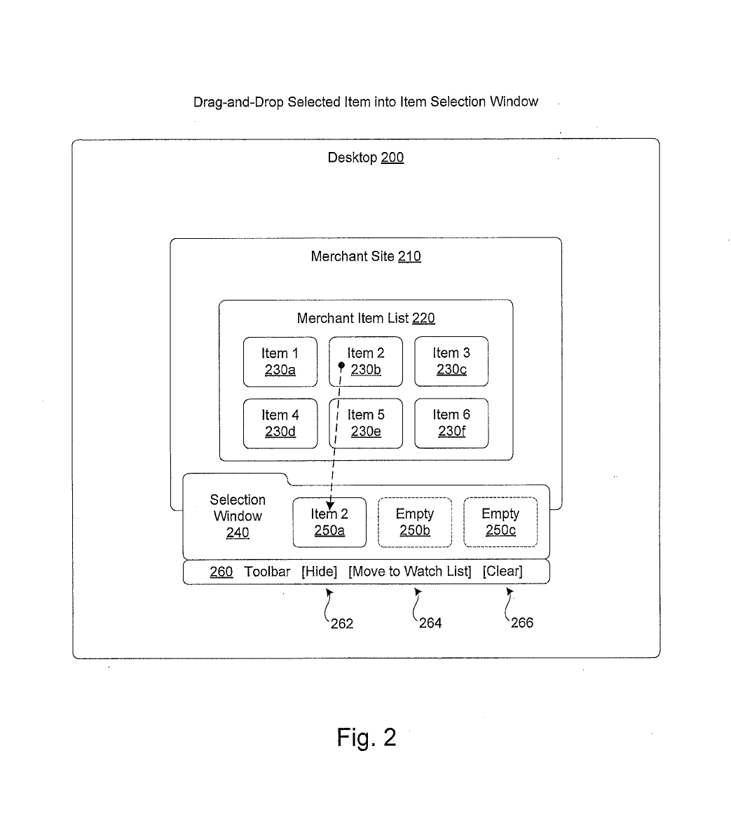

FIG. 2 shows one embodiment of selecting an item icon 230a-230f from a merchant item list 220 and moving (e.g., dragging and dropping) the selected item icon 230a-230f to a selection window 240 as displayed by the client device 120. In one aspect, FIG. 2 shows an image of a computer desktop 200 displaying a browser window 210 of a merchant site with the merchant item list 220 having one or more item icons 230a-230f as part thereof FIG. 2 also shows an image of the selection window 240 having one or more item selection boxes 250a-250c (e.g., as shown with or without an item icon and/or empty) adapted to receive at least one item icon 230a-230f when transferred from the merchant item list 220.

In one embodiment, referring to FIG. 2, a display component of the client device 120 may be adapted to display, in an environment of the computer desktop 200, the merchant site in the browser window 210, the item list 220 having the one or more of the item icons 230a-230f, and the selection window 240 having the item selection boxes 250a-250c. In one implementation, referring to FIGS. 1 and 2, the user 102 utilizes the browser application 122 to open the browser window 210 and access a merchant server 140 via a merchant site to view the merchant item list 220 having the one or more items (i.e., item icons 230a-230f) for viewing, selection, and/or purchase. When executed, the user interface application 122 is adapted to provide the selection window 240 on the desktop environment 200 so that the user 102 may select and drag at least one item icon 230a-230f to the selection window 240 for viewing, monitoring, comparing, and/or purchase and then drop the selected item icon 230a-230f over the selection item boxes 250a-250c to hold for processing with the merchant server 140 and the service provider 180, in a manner as discussed herein. Once selected and placed in the selection window, the user 102 may monitor the price of the selected items, compare the selected items, and/or request purchase of the selected items.

In one embodiment, referring to FIG. 2, a display component of the client device 120 may be adapted to display, in the desktop environment 200, a toolbar 260 in the browser window 210 with one or more user selectable operations including a show/hide operation 262, a move-to-watch-list operation 264, and a clear operation 266. The show/hide operation 262 allows the user 102 to hide or show (i.e., minimize or maximize) the selection window 240 as desired, and when hidden or minimized, the user 102 may drag-and-drop one or more item icons 230a-230f onto the hidden or minimized selection window 240. The move-to-watch-list operation 264 allows the user 102 to move or transfer one or more items (i.e., item icons 230a-230f) to a watch list (not shown), which allows the user 102 monitor the items, e.g., for price increases, price decreases, item availability, etc. In one aspect, the watch list may comprise another website or window having a watch list of items that the user 102 wants to store or save for further processing at another time. The clear operation 266 allows the user 102 to clear one or more item icons 230a-230f from the selection window 240 by, e.g., removing the item icons from the selection window 240.

Referring to FIG. 2, one or more items, products, and/or services may be moved or transferred from the merchant item list 220 to the selection window 240, gathered in an array, and carried with the user 102 during navigation and shopping events. The selection window 240 allows the user 102 to organize and display selected items, products, and/or services in a convenient and efficient manner. As shown in FIG. 2, one or more item icons (e.g., item 2 icon 230b may be selected, dragged, and dropped onto an item selection box (e.g., item selection box 250a) for sorting and processing. In one implementation, the selection window 240 may comprise a browser add-on or plug-in that follows the user 102 during navigation and shopping events. The selection window 240 may be utilized for storing, sifting, and/or sorting through selected items, products, and/or services. In one aspect, the selection window 240 may be referred to as a collection agent or array for selected items, products, and/or services as collected by the user 102 during navigation and shopping events. In another aspect, there may be no indication (e.g., dashed lines) of item selection boxes 250a, 250b, 250c in the selection window 240 where the user 102 should drop a selected item. As such, in one implementation, the item selection windows 250a, 250b, 250c may be hidden from the user's view (i.e., not shown or indicated) in the selection window 240, and the user 102 may drop one or more selected items anywhere within the selection window 240 to place the one or more selected items in the selection window 240.

In various implementations, the selection window 240 allows the user 102 to drag-and-drop one or more merchant items during navigation and shopping events. The toolbar 260 allows the user 102 to show or hide the selection window, as desired. However, even when the selection window 240 is hidden, the user 102 may move merchant items onto the selection window 240. In one aspect, the selection window 240 allows the user 102 to use left and right keyboard arrows of a user input device, such as a keyboard, to shift through item selection boxes 250a, 250b, 250c. The selection window 240 allows the user 102 to select a plurality of merchant items (e.g., 2 or more items) for comparison and purchase consideration. The selection window 240 allows the user 102 to highlight item selection boxes for comparison of desired or wanted merchant items for purchase consideration. The selection window 240 allows the user 102 to decide which merchant items are wanted and then move the wanted items into a watch list related to the user 102. The selection window 240 is adapted to be displayed anywhere inside and outside the browser window. The selection window 240 allows the user 102 to hold selected merchant items for a predetermined time period (e.g., from minutes to days) or until the user 102 clears browser cookies. The selection window 240 allows the user 102 to remove any of the selected merchant items at any time.

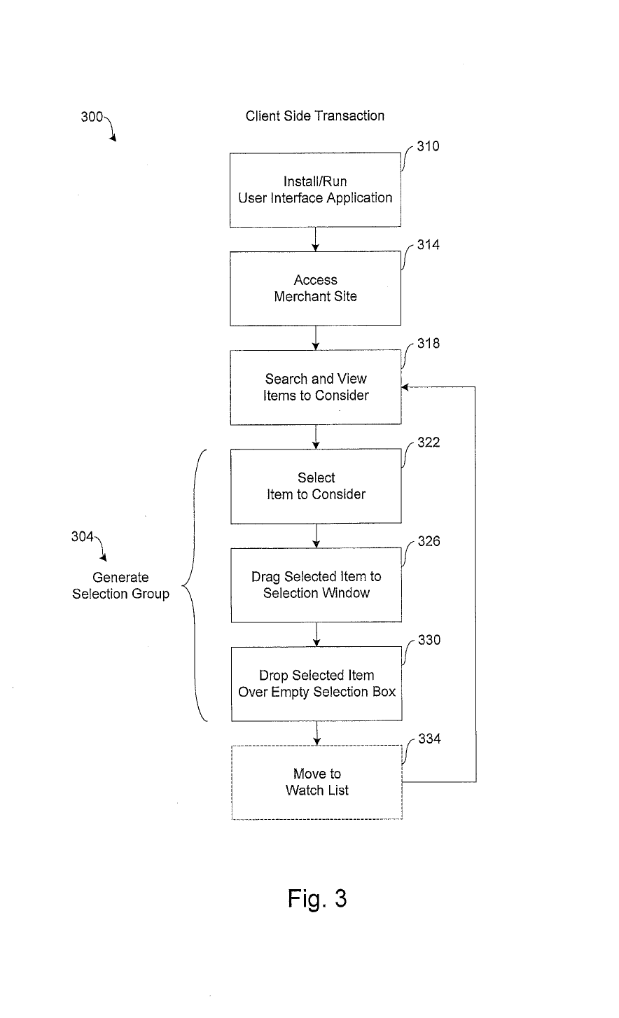

FIG. 3 shows one embodiment of a method 300 for facilitating a client-side selection event over the network 160 with the user interface application 122 in reference to the client device 120. In one aspect, the user interface application 122 allows the client device 120 to communicate with one or more of the merchant servers 140 via the network 160 to select and monitor items, products, and/or services for purchase consideration and further communicate with the service provider 180 to process online financial transactions (e.g., purchase requests) for items, products, and/or services selected for purchase.

In one implementation, upon user instruction, the user interface application 122 may be installed and/or run on the client device 120 (block 314). The user 102 may run the user interface application 122 on the client device 120 to access at least one merchant website via a related merchant server 140 (block 318) to search the accessed merchant website and view items, products, and/or services for purchase consideration (block 318).

In one aspect, upon installation or execution of the user interface application 122, the user 102 may be prompted to establish a user account for login with the service provider 180, wherein the user 102 may use the user interface application 122 and the client device 120 to access the service provider 180 via the network 160. When establishing a user account, the user 102 may be asked to provide personal information, such as name, address, phone number, etc., and financial information, such as banking information, credit card information, etc. In another aspect, referring to FIG. 1, information related to the user 102 may be packaged as the user identifier 130.

Next, to generate a selection group 304, the user 102 may select an item, product, and/or service for purchase consideration (block 322) by selecting the item, product, and/or service (block 320), dragging the at least one selected item, product, and/or service to the selection window 240 (block 326), and dropping the at least one selected item, product, and/or service over an empty selection box 250a, 250b, 250c in the selection window 240 (block 330). In one aspect, the user 102 may drag at least one selected item at a time to anywhere on the selection window 240. In another aspect, the user 102 may select and drag multiple items and drop them into the selection window 240. In still another aspect, there may be no indication (e.g., dashed lines) of selection boxes 250a, 250b, 250c or areas in the selection window 240 where the user 102 should drop an item. As such, the user 102 may drop a selected item anywhere within the selection window 240.

In one implementation, the user selection includes user information, merchant information, and selected item information embedded as arguments in an expression, which are passed to the service provider 180. The user information may include user identifier information, the merchant information may include the merchant identifier information, and the selected item information may include one or more image attributes, including item identifier information, having dynamic arguments identifying the item and merchant providing the item for purchase.

In one implementation, the user interface application 122 may transmit an item identifier along with the user identifier 130 and the merchant identifier 148 to the service provider 180 for processing. When selecting an item for purchase consideration, the user 102 may utilize a cursor control component (e.g., a mouse) to select and drag an item icon or image, representing a selected item for purchase consideration, from the merchant site to the selection window either on the desktop or in the browser. Once the user 102 drops the selected item over the selection window, the selected item is stored and displayed in the selection window 240 for monitoring and/or comparison with other selected items. In one aspect, it should be appreciated that user identification may be provided as the user identifier 130 and passed with the user selection to the service provider 180.

At this point, the user 102 may optionally move one or more items selected for purchase consideration form the selection window to a watch list (block 334) for further monitoring and purchase consideration. In one embodiment, the watch list comprises a stored list of selected items, products, and/or services for purchase consideration, wherein the user 102 is able to access the watch list at any time to update information, update selections, make purchases, and/or complete transactions.

It should be appreciated by those skilled in the art that more than one item may be selected for purchase consideration. As such, the user 102 may continue to shop, search, and view items, products, and/or service for purchase consideration (block 318). Therefore, a plurality of items, products, and/or service may be selected and placed in the selection window 240 and then purchased in a single online purchase transaction. Alternately, each item selected for purchase may be purchased separately without departing from the scope of the present disclosure.

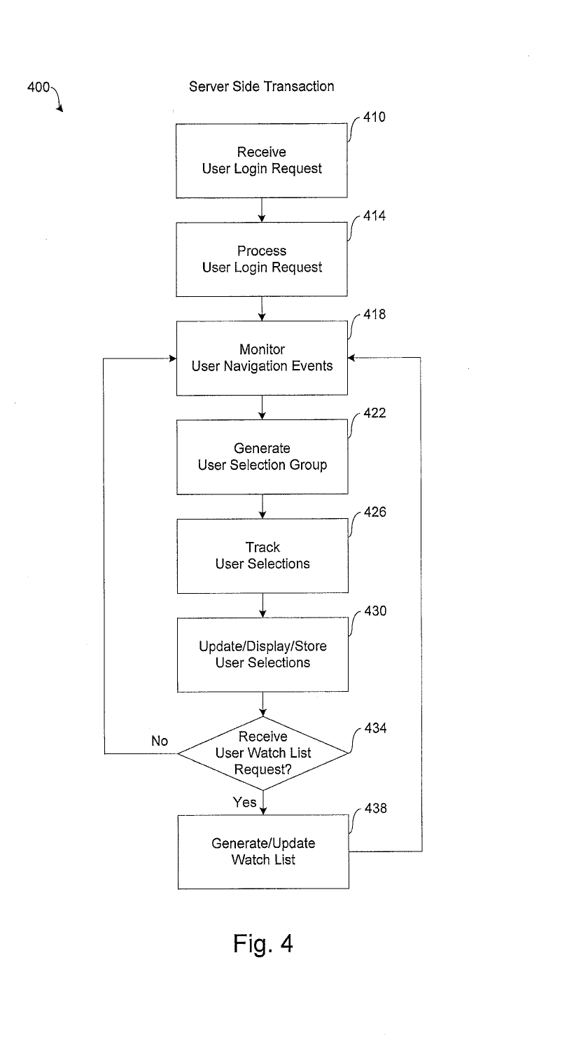

FIG. 4 shows one embodiment of a method 400 for facilitating server-side processing of a user selection event over the network 160 via the selection processing module 186 of the service provider 180 interfacing with the user interface application 122 of the client device 120. In one aspect, the selection processing module 186 allows the service provider 180 to communicate with the client device 120 and the one or more of the merchant servers 140 via the network 160 to monitor items, products, and/or services selected by the user 102 for purchase consideration. The service provider 180 is adapted to process online financial transactions (e.g., process purchase requests) on behalf of the user 102 and the one or more merchants 140 in reference to items, products, and/or services selected for purchase.

In one implementation, the service provider 180 receives a login request from the user 102 via the client device 120 (block 414), and then the service provider 180 processes the user login request (block 141). Upon receiving the user login request, the service provider 180 may determine whether the user 102 is an existing user having an established user account 184 by, e.g., checking a user account list in a user account database. If the user 102 does not have an established user account, then the service provider 180 prompts the user 102 to establish a user account 184 by providing user information 186, and the service provider 180 uploads the user interface application 122 to the client device 120 so that the user 102 may install and run the user interface application 122 on client device 120. Once the user interface application 122 is installed and run on the client device 120, the service provider 180 begins to monitor user navigation and shopping events (block 418). Otherwise, if the user 102 is determined to be an existing user by the service provider 180, then the service provider 180 verifies the user account and user identification information provider by user 102 in the user login request. The service provider 180 may determine if the user account is current and active. In some instances, user account information may need to be updated, and thus, the service provider 180 may prompt the user 102 to update user account information 186 in the user account 184 for the user 102. However, if the user account 184 is current and active, then the service provider 180 begins to monitor user navigation and shopping events (block 418). It should be appreciated by those skilled in the art that the service provider 180 may cancel the user login request at any time during the process of method 400 if, e.g., it is determined by the service provider 180 that the user 102 enters wrong information or the user 102 is trying to purchase an item with criminal intent.

Next, the service provider 180 is adapted to monitor user navigation and shopping events (block 418) via communication between the selection processing module 186 of the service provider 180 and the user interface application 122 of the client device 120. Based on user selection information received from the client device 120, the service provider is adapted to generate a user selection group (block 422). In one aspect, the user selection group comprises one or more selected merchant items for purchase consideration as provided in the selection window 240 by the user 102.

Next, the service provider 180 is adapted to track user selections (block 426) by monitoring the selection group and the selection window 240 as provided by the user 102.

Next, the service provider 180 is adapted to update the user selections in the section window, display the user selections in the selection window, and/or store the user selections for processing (block 430). For example, the service provider 180 may update the selection window based on user requested change to the selection group. The user selections may be constantly updated, when, e.g., the user 102 makes changes (e.g., additions, deletions, movements, etc.) to the selection group via the selection window 240. In another example, the service provider 180 is adapted to display updated selection group information to the user 102 via the selection window 240. In still another example, the service provider 180 may store, either temporarily or permanently, the user item selections and/or any changes to the user item selections for reference and other additional processing.

Next, the service provider 180 determines whether the user 102 requests movement of one or more selected items from the selection window 240 to a watch list related to the user 102 (block 434). If no, then the service provider server 180 continues to monitor the user navigation and shopping events (block 418). Otherwise, if yes, then the service provider 180 generates or updates a previously generated a watch list for the user 102) (block 438). In one aspect, the service provider 180 links the generated watch list, and item selection information related thereto, to a user account in the account database 192 related to the user 102. This allows the service provider 180 to monitor and update the user's watch list for the user 102, as instructed and/or requested by the user 102. Next, after generating or updating the user's watch list, the service provider server 180 continues to monitor user navigation and shopping events (block 418).

Optionally, the service provider 180 may process a purchase request and any related purchase information provided by the user 102. The purchase request and/or the purchase information may include information related to the items selected for purchase consideration in the selection group, information related to the merchant providing the selected items for purchase consideration, information related to the user including user account number, balance information, credit card information, etc. In one aspect, the service provider 180 may optionally access the merchant site via the merchant server 140 to verify purchase information including verifying that the selected item is available (e.g., in stock), verifying the pricing information, verifying that the merchant account is up-to-date, etc.. The service provider 180 may prompt the user 102 via, e.g., a pop-up window, to verify a purchase request. For example, the service provider 180 may ask the user 102 to complete the purchase transaction by selecting a designated box to complete the purchase transaction. In this way, the service provider 180 is adapted to allow the user 102 to request processing and/or cancellation of any online financial transactions prior to completion.

Optionally, based on user request, the service provider 180 may complete any online financial transactions by deducting the amount of the purchase request from the user account and crediting the amount of the purchase request to a related merchant account. In one aspect, completing a purchase request may include redirecting the user 102 to a page on the merchant site that confirms their purchase of the selected product to provide, e.g., a receipt to the user 102. In one embodiment, the selection window may include a payment mechanism that allows the user 102 to take different actions, such as making purchase requests and providing buttons to complete the purchase at a later time.

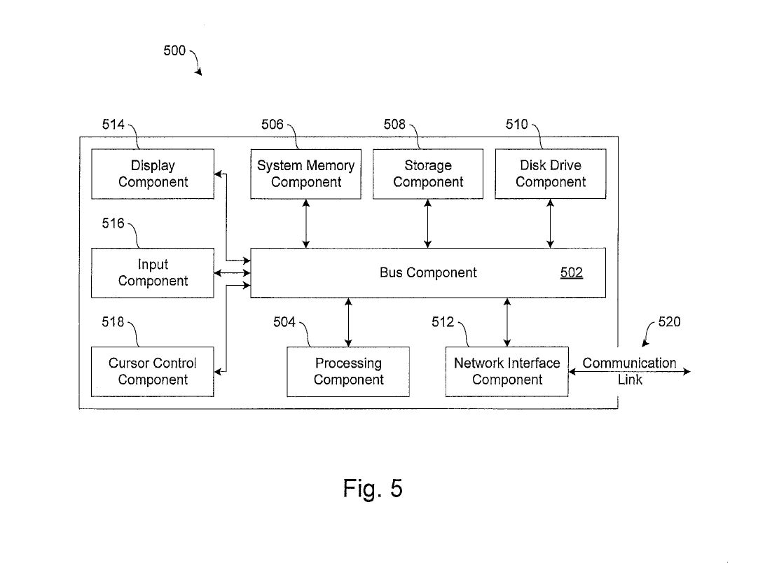

FIG. 5 is a block diagram of a computer system 500 suitable for implementing one or more embodiments of the present disclosure, including the client device 120, the one or more merchant devices 140, and the service provider device 180. In various implementations, the client device 140 may comprise a personal computing device capable of communicating with the network 160, such as a personal computer, laptop, cell phone, PDA, etc., the one or more merchant devices 140 may comprise a network computing device, such as a network server, and the service provider device 180 may comprise a network computing device, such as a network server. Hence, it should be appreciated that each of the devices 120, 140, 180 may be implemented as computer system 500 in a manner as follows.

In accordance with various embodiments of the present disclosure, computer system 500, such as a personal computer and/or a network server, includes a bus 502 or other communication mechanism for communicating information, which interconnects subsystems and components, such as processing component 504 (e.g., processor, micro-controller, digital signal processor (DSP), etc.), system memory component 506 (e.g., RAM), static storage component 508 (e.g., ROM), disk drive component 510 (e.g., magnetic or optical), network interface component 512 (e.g., modem or Ethernet card), display component 514 (e.g., CRT or LCD), input component 516 (e.g., keyboard), and cursor control component 518 (e.g., mouse or trackball). In one implementation, disk drive component 510 may comprise a database having one or more disk drive components.

In accordance with embodiments of the present disclosure, computer system 500 performs specific operations by processor 504 executing one or more sequences of one or more instructions contained in system memory component 506. Such instructions may be read into system memory component 506 from another computer readable medium, such as static storage component 508 or disk drive component 510. In other embodiments, hard-wired circuitry may be used in place of or in combination with software instructions to implement the present disclosure.

Logic may be encoded in a computer readable medium, which may refer to any medium that participates in providing instructions to processor 504 for execution. Such a medium may take many forms, including but not limited to, non-volatile media, volatile media, and transmission media. In various implementations, non-volatile media includes optical or magnetic disks, such as disk drive component 510, volatile media includes dynamic memory, such as system memory component 506, and transmission media includes coaxial cables, copper wire, and fiber optics, including wires that comprise bus 502. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 520 (e.g., network 160 of FIG. 1, such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 520 and communication interface 512. Received program code may be executed by processor 504 as received and/or stored in disk drive component 510 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa. Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A system for facilitating transactions over a network, the system comprising:
a non-transitory memory;
one or more hardware processors coupled to the non-transitory memory and configured to read instructions from the non-transitory memory to cause the system to perform operations comprising:
monitoring user navigation events over the network between different merchant websites, wherein the user navigation events comprises website navigation between the different merchant websites and user selections of items for purchase from each of the different merchant websites in a browser application;
generating a user selection group based on the user selections of items from a plurality of merchant websites of the different merchant websites, wherein the user selection group comprises the user selections moved to a user interface application via drag-and-drop of an icon from a merchant website of the different merchant websites;
displaying the user selections from the different merchant websites accessed in the browser application to the user via an interface of a user interface application separate from the browser application, wherein the user interface application comprises a hide function for the user interface application to hide the user interface application; and
processing a purchase of the items from the different merchant websites through the user interface application in a single online purchase transaction without the user navigating to the each of the different merchant websites.

2. The system of claim 1, wherein the operations further comprise:
storing a user account associated with the user, wherein the user account includes user personal information and user financial information for the user,
wherein the purchase of the items is processed using the user account.

3. The system of claim 2, wherein the operations further comprise:
receiving a user login request from the user for the user account; and
verifying an identity of the user using the user login request;
determining the user account for the user; and
processing the user login request for the user account based on the verifying the identity of the user.

4. The system of claim 1, wherein the operations further comprise:
updating the interface of the user interface application based on additional user selections from the each of the different merchant websites in the browser application; and
storing the user selections and the additional user selections in the interface of the user interface application.

5. The system of claim 1, wherein the user navigation events comprise user shopping actions with the each of the different merchant websites, and wherein the user shopping actions comprise searching for the items to purchase from the different merchant websites.

6. The system of claim 1, wherein the icon represents at least one of an item, product, and service displayed by the merchant website for purchase by the user.

7. The system of claim 1, wherein the user interface application allow the user to access the different merchant websites and review the items for purchase by the user, and wherein the user interface application further displays the icon from the merchant website.

8. A method comprising:
monitoring user navigation events over the network between different merchant websites, wherein the user navigation events comprises website navigation between the different merchant websites and user selections of items for purchase from each of the different merchant websites in a browser application;
generating a user selection group based on the user selections of items from a plurality of merchant websites of the different merchant websites, wherein the user selection group comprises the user selections moved to a user interface application via drag-and-drop of an icon from a merchant website of the different merchant websites;
displaying the user selections from the different merchant websites accessed in the browser application to the user via an interface of a user interface application separate from the browser application, wherein the user interface application comprises a hide function for the user interface application to hide the user interface application; and
processing a purchase of the items from the different merchant websites through the user interface application in a single online purchase transaction without the user navigating to the each of the different merchant websites.

9. The method of claim 8, further comprising:
storing a user account associated with the user, wherein the user account includes user personal information and user financial information for the user,
wherein the purchase of the items is processed using the user account.

10. The method of claim 9, further comprising:
receiving a user login request from the user for the user account; and
verifying an identity of the user using the user login request;
determining the user account for the user; and
processing the user login request for the user account based on the verifying the identity of the user.

11. The method of claim 8, further comprising:
updating the interface of the user interface application based on additional user selections from the each of the different merchant websites in the browser application; and
storing the user selections and the additional user selections in the interface of the user interface application.

12. The method of claim 8, wherein the user navigation events comprise user shopping actions with the each of the different merchant websites, and wherein the user shopping actions comprise searching for the items to purchase from the different merchant websites.

13. The method of claim 8, wherein the icon represents at least one of an item, product, and service displayed by the merchant website for purchase by the user.

14. The method of claim 8, wherein the user interface application allow the user to access the different merchant websites and review the items for purchase by the user, and wherein the user interface application further displays the icon from the merchant website.

15. A non-transitory machine-readable medium having stored thereon machine-readable instructions executable to cause a machine to perform operations comprising:
monitoring user navigation events over the network between different merchant websites, wherein the user navigation events comprises website navigation between the different merchant websites and user selections of items for purchase from each of the different merchant websites in a browser application;
generating a user selection group based on the user selections of items from a plurality of merchant websites of the different merchant websites, wherein the user selection group comprises the user selections moved to a user interface application via drag-and-drop of an icon from a merchant website of the different merchant websites;
displaying the user selections from the different merchant websites accessed in the browser application to the user via an interface of a user interface application separate from the browser application, wherein the user interface application comprises a hide function for the user interface application to hide the user interface application; and
processing a purchase of the items from the different merchant websites through the user interface application in a single online purchase transaction without the user navigating to the each of the different merchant websites.

16. The non-transitory machine-readable medium of claim 15, further comprising:
storing a user account associated with the user, wherein the user account includes user personal information and user financial information for the user,
wherein the purchase of the items is processed using the user account.

17. The non-transitory machine-readable medium of claim 16, further comprising:
receiving a user login request from the user for the user account; and verifying an identity of the user using the user login request; determining the user account for the user; and
processing the user login request for the user account based on the verifying the identity of the user.

18. The non-transitory machine-readable medium of claim 15, further comprising:
updating the interface of the user interface application based on additional user selections from the each of the different merchant websites in the browser application; and
storing the user selections and the additional user selections in the interface of the user interface application.

19. The non-transitory machine-readable medium of claim 15, wherein the user navigation events comprise user shopping actions with the each of the different merchant websites, and wherein the user shopping actions comprise searching for the items to purchase from the different merchant websites.

20. The non-transitory machine-readable medium of claim 15, wherein the user interface application allow the user to access the different merchant websites and review the items for purchase by the user, and wherein the user interface application further displays the icon from the merchant website.
